(19) United States
(12) Patent Application Publication
(10) Pub. No.: US 2026/0179984 A1
(43) Pub. Date: Jun. 25, 2026

(54) SYSTEM AND METHOD FOR CONTROLLING AIR SUPPLY TO FUEL CELL

(71) Applicants: Hyundai Motor Company, Seoul (KR); Kia Corporation, Seoul (KR)

(72) Inventor: Jae Kwon JUNG, Hwaseong-Si (KR)

(21) Appl. No.: 19/307,595

(22) Filed: Aug. 22, 2025

(30) Foreign Application Priority Data
Dec. 19, 2024 (KR) 10-2024-0190657

(51) Int. Cl. H01M 8/04746; H01M 8/04537; H01M 8/04858

(52) U.S. Cl. CPC H01M 8/04753; H01M 8/04589; H01M 8/04619; H01M 8/04626; H01M 8/04649; H01M 8/0488; H01M 8/0494

(57) ABSTRACT

An apparatus of a fuel cell system may comprise a current-voltage curve estimation circuit configured to estimate, based on a state of health (SoH) of a fuel cell stack of the fuel cell system, a current-voltage performance curve of the fuel cell stack, a lower limit current determination circuit configured to determine whether a current of the fuel cell stack is less than or equal to a lower limit current of the fuel cell stack, wherein the lower limit current is determined based on the SoH of the fuel cell stack under a condition in which a flow rate of air supplied to the fuel cell stack is reduced to maintain a voltage of the fuel cell stack within a voltage upper limit control region, an air flow rate increase control circuit, and a power load.

### CROSS-REFERENCE TO RELATED APPLICATION

This application claims under 35 U.S.C. § 119(a) the benefit of priority to Korean Patent Application No. 10-2024-0190657 filed in the Korean Intellectual Property Office on Dec. 19, 2024, the entire contents of which are incorporated herein by reference.

### TECHNICAL FIELD

The present disclosure relates to a system and method for controlling air supply to a fuel cell. More particularly, it relates to a system and method for controlling air supply to a fuel cell enabling prevention of a decrease in minimum cell voltage ratio during low-flow control for supplying air to a fuel cell stack.

### BACKGROUND

The matters described in this Background section are only for enhancement of understanding of the background of the disclosure, and should not be taken as acknowledgment that they correspond to prior art already known to those skilled in the art.

A fuel cell system may include a fuel cell stack (shortened to stack hereinafter) in which a plurality of fuel cells is stacked and assembled to generate electrical energy, a fuel supply system that supplies new fuel (hydrogen) and recycled hydrogen to the stack, an air supply system that supplies oxygen in the air, which is an oxidizing agent used for an electrochemical reaction in the stack, a thermal management system that removes reaction heat of the stack to the outside of the system and controls an operating temperature of the stack, etc.

One of a main control item of the fuel cell system may be air supply control to supply an appropriate air flow from the air supply system to the stack in which the plurality of fuel cells (hereinafter referred to as cells) is stacked and assembled.

For example, the air supply control may include a process in which a target air supply amount (target air flow rate) of air to be supplied to the stack is determined based on required output of the stack, a process in which a rotation speed of an air blower, which is a type of compressor, is controlled based on the determined target air supply amount, etc.

For example, the supply amount of air supplied to the stack, for example, the air flow rate, may be physically measured and controlled. Depending on the operating section of the stack, the amount may be boosted when compared to an actually required air flow rate, or may be precisely adjusted to the required air flow rate.

A reason for supplying air to the stack by boosting the air flow rate is to prevent vacuum from being temporarily generated inside the stack when air is quickly exhausted due to rapid electrochemical reaction between hydrogen and oxygen in a high-power section of the stack, and to prevent an air shortage phenomenon due to dynamic output fluctuation of the stack.

On the other hand, in a low-power section of the stack, low-flow control is performed to precisely control the air flow rate supplied to the stack without boosting, and this low-flow control is performed in relation to voltage upper limit control in the low-power section of the stack.

The voltage upper limit control refers to controlling a cell voltage of the stack so that the cell voltage does not exceed an upper limit voltage (for example, 0.8 to 0.85 V), considering that the cell voltage of the stack being output in a high range greater than the upper limit voltage has a negative effect on durability of the stack.

To this end, control may be performed so that, if the cell voltage of the stack approaches the upper limit voltage in the low-power section of the stack where the required output of the stack is lowered, an upper controller or a power distributor reduces the air flow rate supplied to the stack to follow the required output of the stack. A control section thereof is referred to as a low-flow control section.

### SUMMARY

The present disclosure has been made in an effort to solve the above-described problems.

According to the present disclosure, an apparatus of a fuel cell system, the apparatus may comprise a current-voltage curve estimation circuit configured to estimate, based on a state of health (SoH) of a fuel cell stack of the fuel cell system, a current-voltage performance curve of the fuel cell stack, a lower limit current determination circuit configured to determine whether a current of the fuel cell stack is less than or equal to a lower limit current of the fuel cell stack, wherein the lower limit current is determined based on the SoH of the fuel cell stack under a condition in which a flow rate of air supplied to the fuel cell stack is reduced to maintain a voltage of the fuel cell stack within a voltage upper limit control region, an air flow rate increase control circuit configured to increase, based on the current of the fuel cell stack being less than or equal to the lower limit current, the flow rate of air supplied to the fuel cell stack, and a power load configured to receive and use excess power generated in the fuel cell stack as the flow rate of air supplied to the stack increases.

The apparatus, wherein the air flow rate increase control circuit may comprise a power consumption determination circuit configured to measure power used by the power load, a stack requirement power increase determination circuit configured to determine, based on the measured power, stack requirement power, and a driving control circuit configured to control, based on the determined stack requirement power, a rotation speed of an air blower to adjust the flow rate of air supplied to the fuel cell stack.

The apparatus, wherein the air flow rate increase control circuit is configured to increase the flow rate of air supplied to the fuel cell stack in the voltage upper limit control region. The apparatus, wherein the air flow rate increase control circuit is configured to stop, based on a required current exceeding the lower limit current of the fuel cell stack, increasing the flow rate of air.

The apparatus, wherein the power consumption determination circuit is configured to, determine usable power to be at least one of Cathode Oxygen Depletion (COD) consumable power, battery rechargeable power, or Balance of Plant (BOP) consumable power, or determine consumable power based on a sum of the COD consumable power, the battery rechargeable power, and the BOP consumable power.

The apparatus, wherein the stack requirement power increase determination circuit is configured to determine the stack requirement power based on a sum of commanded stack requirement power and usable power, wherein the usable power is determined by the power consumption determination circuit.

The apparatus may further comprise a power consumption control circuit configured to, determine excess power generated in the fuel cell stack, and control the power load to use the determined excess power.

The apparatus, wherein the power consumption control circuit is configured to determine the excess power based on, a difference between a required output power and an output power of the fuel cell stack, and a current of the fuel cell stack exceeding a required current associated with the required output power.

The apparatus, wherein the power load may comprise at least one of a cathode oxygen depletion (COD) resistor, a battery, or a balance of plant (BOP) component.

According to the present disclosure, a method performed by an apparatus of a fuel cell system, the method may comprise estimating, based on a state of health (SoH) of a fuel cell stack of the fuel cell system, a current-voltage performance curve of the fuel cell stack, determining whether a current of the fuel cell stack is less than or equal to a lower limit current of the fuel cell stack, wherein the lower limit is determined based on the SoH of the fuel cell stack under a condition in which a flow rate of air supplied to the fuel cell stack is reduced to maintain a voltage of the fuel cell stack within a voltage upper limit control region, increasing, based on the current of the fuel cell stack being less than or equal to the lower limit current, the flow rate of air supplied to the fuel cell stack, and transferring, to a power load of the apparatus, excess power generated in the fuel cell stack as the flow rate of air supplied to the stack increases.

The method, wherein the increasing of the flow rate of air may comprise measuring power used by the power load, determining, based on the measured power, stack requirement power, and controlling, based on the determined stack requirement power, a rotation speed of an air blower to adjust the flow rate of air supplied to the fuel cell stack.

The method may further comprise based on a required current exceeding the lower limit current of the fuel cell stack, stop increasing the flow rate of air. The method, wherein the measuring of power used by the power load may comprise determining usable power to be at least one of Cathode Oxygen Depletion (COD) consumable power, battery rechargeable power, or Balance of Plant (BOP) consumable power, or determining consumable power based on a sum of the COD consumable power, the battery rechargeable power, and the BOP consumable power.

The method, wherein the determining of the stack requirement power may comprise determining the stack requirement power based on a sum of commanded stack requirement power and usable power. The method may further comprise determining excess power generated in the fuel cell stack, and controlling the power load to use the determined excess power.

The method, wherein the determining of the excess power may comprise determining the excess power based on, a difference between a required output power and an output power of the fuel cell stack, and a current of the fuel cell stack exceeding a required current associated with the required output power.

The method, wherein the power load may comprise at least one of a cathode oxygen depletion (COD) resistor, a battery, and a balance of plant (BOP) component.

According to the present disclosure, an apparatus of a fuel cell system, the apparatus may comprise a processor, and a memory storing at least one instruction that, when executed by the processor communicating with the memory, is configured to cause the apparatus to, identify, based on a performance characteristic of a fuel cell stack of the fuel cell system, a threshold current value for maintaining a target operating condition of the fuel cell stack, compare, based on a flow rate of air supplied to the fuel cell stack being reduced to control a voltage of the fuel cell stack, an operating current of the fuel cell stack to the threshold current value, generate, based on the operating current being less than or equal to the threshold current value, a signal indicating to increase the flow rate of air supplied to the fuel cell stack, identify an amount of electrical power resulting from the increased flow rate of air, and control a load of the fuel cell system to use at least a portion of the electrical power.

The apparatus, wherein the threshold current value is associated with a state of health (SoH) value of the fuel cell stack. The apparatus, wherein the at least one instruction, when executed by the processor communicating with the memory, is configured to cause the apparatus to, determine that the fuel cell stack is operating in a low-power mode based on the operating current of the fuel cell stack less than or equal to the threshold current value, and initiate, based on the determination that the fuel cell stack is operating in the low-power mode, an increase in the flow rate of air supplied to the fuel cell stack.

Other examples and preferred examples of the disclosure are discussed infra. The above and other features of the disclosure are discussed infra.

### BRIEF DESCRIPTION OF THE DRAWINGS

The above and other features of the present disclosure will now be described in detail with reference to certain examples thereof illustrated the accompanying drawings which are given hereinbelow by way of illustration only, and thus are not limitative of the present disclosure, and wherein:

FIG. 1 shows an example of a current-voltage curve of a stack in which a low-flow control section is indicated;

FIG. 2 shows an example of a system for controlling air supply to a fuel cell according to the present disclosure;

FIG. 3 shows an example of a method of controlling air supply to the fuel cell according to the present disclosure;

FIG. 4 shows an example of a current-voltage curve of a stack for describing the method of controlling air supply to the fuel cell according to the present disclosure; and

FIG. 5 shows an example of an example of estimating a current-voltage curve of a current using an SoH of a stack in the method of controlling air supply to the fuel cell according to the present disclosure.

FIG. 6 shows an example computing system.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Specific structural or functional descriptions presented in the examples of this specification are only illustrative for the purpose of describing examples according to the concept of the present disclosure, and the examples according to the concept of the present disclosure may be implemented in various forms. In addition, the present disclosure should not be construed as being limited to the examples described herein, and should be understood to include all modifications, equivalents, and substitutes included in the spirit and scope of the present disclosure.

In this specification, even though terms such as “first,” “second,” etc. may be used to describe various elements, the elements are not limited by these terms. These terms are only used to distinguish one element from another. For example, within the scope not departing from the scope of rights according to the concept of the present disclosure, a first element may be referred to as a second element, and similarly, the second element may be referred to as the first element.

In this specification, when an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween. Other expressions for describing a relationship between elements, for example, expressions such as “between” and “immediately between” or “adjacent to” and “directly adjacent to”, should be interpreted similarly.

Like reference numerals refer to like elements throughout this specification. The terminology used herein is for the purpose of describing the examples, and is not intended to limit the present disclosure. In this specification, a singular expression includes the plural form unless the context clearly dictates otherwise. Referring to expressions “comprises” and/or “comprising” used in the specification, a mentioned component, step, operation, and/or element does not exclude the presence or addition of one or more other components, steps, operations, and/or elements.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Hereinafter, a preferred example of the present disclosure will be described in detail with reference to the attached drawings.

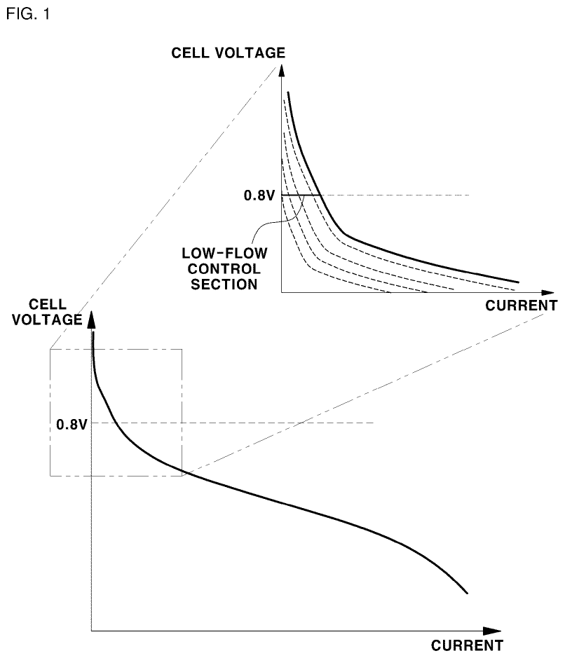

FIG. 1 shows an example of a current-voltage curve of a stack in which a low-flow control section is indicated. In the low-flow control section, the cell voltage of the stack may be controlled below the upper limit voltage (for example, 0.8 to 0.85 V), as shown in a graph of FIG. 1. In this way, by supplying air at an air flow rate determined according to the required output of the stack by the low-flow control to the stack, control may be performed so that the cell voltage of the stack does not to exceed the upper limit voltage, and unnecessary current exceeding output or cell voltage increase of the stack may be prevented. However, such a low-flow control may cause the following problems.

First, when performing low-flow control by the upper controller, there is a problem that an imbalance in the air supply in the stack may occur (for example, an imbalance may occur between inlet and outlet flow rates of the stack), which may lower a minimum cell voltage ratio (RV) of the stack, resulting in a decrease in cell performance of the stack and a decrease in durability of the stack.

For reference, the minimum cell voltage ratio (RV) refers to a value obtained by dividing the minimum cell voltage of the stack by an average cell voltage. As the minimum cell voltage ratio decreases, it may be determined that a voltage of a specific cell among a plurality of cells included in the stack has decreased below a lower limit, resulting in a decrease in cell performance.

Second, when the required output of the stack is lowered, the air flow rate supplied to the stack is reduced due to the low-flow control, and voltage upper limit control is performed so that the cell voltage of the stack does not exceed the upper limit voltage. However, there is a problem in that the minimum cell voltage ratio is likely to decrease due to insufficient air flow rate during this voltage upper limit control.

For example, when the required output of the stack is lowered and the cell voltage reaches the upper limit voltage (for example, 0.8 V), the air flow rate supplied to the stack by the low-flow control may be reduced. Therefore, as shown in FIG. 1 showing an example of a current-voltage performance curve of the stack, voltage upper limit control is performed in which an operating point of the stack is limited to a thin solid line section indicated as the low-flow control section. Accordingly, the cell voltage of the stack may be controlled so that the cell voltage does not exceed the upper limit voltage. However, there is a problem in that a possibility of a decrease in the minimum cell voltage ratio due to insufficient air flow rate during voltage upper limit control increases.

For example, in voltage upper limit control in which the operating point of the stack is limited to the thin solid line section indicated as the low-flow control section, when the air flow rate supplied to the stack is reduced and the stack is operated while the voltage of the stack is fixed using an FDC (Fuel Cell DC-DC Converter), as shown in FIG. 1, the current-voltage performance curve of the stack gradually changes from a thick solid line to a dotted line, and voltage upper limit control is performed so that the operating point of the stack is limited to the thin solid line section indicated as the low-flow control section. However, there is a problem that the minimum cell voltage ratio is likely to decrease due to insufficient air flow rate in this voltage upper limit control.

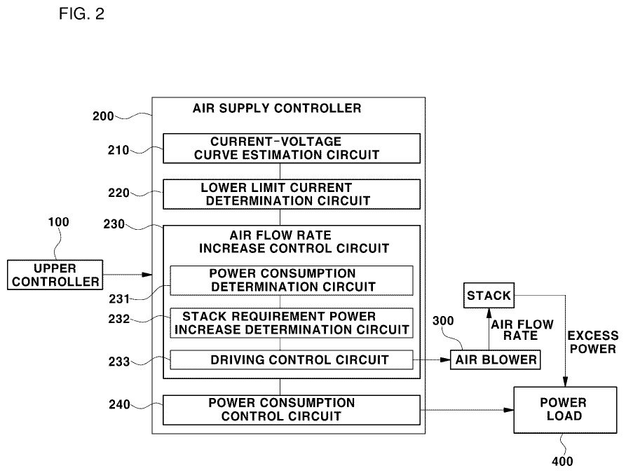

FIG. 2 shows an example of a system for controlling air supply to a fuel cell according to the present disclosure.

As illustrated in FIG. 2, the system for controlling air supply to the fuel cell according to the present disclosure includes an upper controller 100, an air supply controller 200 that performs air supply control to a stack according to a command of the upper controller 100, an air blower 300, and a power consumption load 400 (e.g., a cathode oxygen depletion (COD) resistor, a high-voltage battery, or a balance of plant (BOP) device such as a coolant pump or air compressor, etc.).

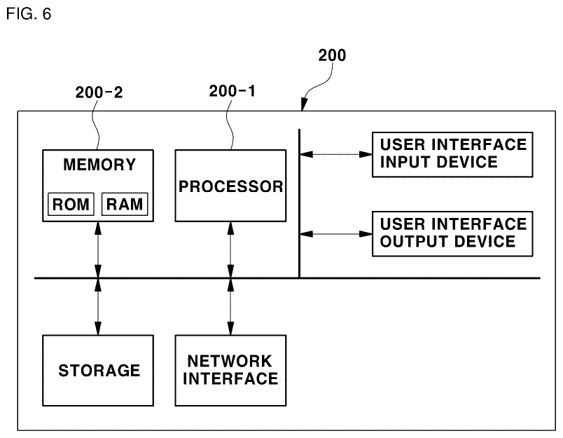

Referring to FIG. 6, the air supply controller 200 and the upper controller 100 may include a processor 200-1 and a memory 200-2.

The processor 200 includes a current-voltage curve estimation circuit, a lower limit current determination circuit, an air flow rate increase control circuit and the like.

The air supply controller 200 may include a current-voltage curve estimation circuit 210, a lower limit current determination circuit 220, an air flow rate increase control circuit 230, and a power consumption control circuit 240 (e.g., implemented as separate software modules, integrated firmware components, or dedicated hardware logic blocks, etc.).

The current-voltage curve estimation circuit 210 of the air supply controller 200 is configured to estimate the current-voltage performance curve of the current stack to determine the low-flow control (voltage upper limit control) area using the SoH of the stack (e.g., by referencing pre-calibrated I-V datasets, applying regression models, using interpolation between BOL and EOL curves, or employing a neural network-based estimator, etc.).

The current-voltage curve estimation circuit 210 of the air supply controller 200 is configured to estimate a current-voltage performance curve of a current stack to determine a low-flow control (voltage upper limit control) region using an SoH of the stack (e.g., for preventing cell voltages from exceeding 0.8 V, 0.82 V, 0.85 V, or other application-specific limits, etc.).

The SoH of the stack is expressed in [%] and is used as an indicator of a current performance state of the stack. When the SoH of the current stack is known, the current-voltage performance curve of the current stack may be estimated using the SoH (e.g., by interpolating between a birth-of-life (BOL) reference curve and an end-of-life (EOL) degradation curve, or by referencing a pre-characterized lookup table, etc.).

For example, as shown in the graph of FIG. 5, the current-voltage performance curve of the stack according to the SoH of the current stack may be determined between a predetermined Birth of Life (BoL) line and an End of Life (EoL) line of the fuel cell by the current-voltage curve estimation circuit 210 (e.g., by applying linear interpolation, piecewise polynomial fitting, or real-time performance mapping using onboard diagnostics, etc.).

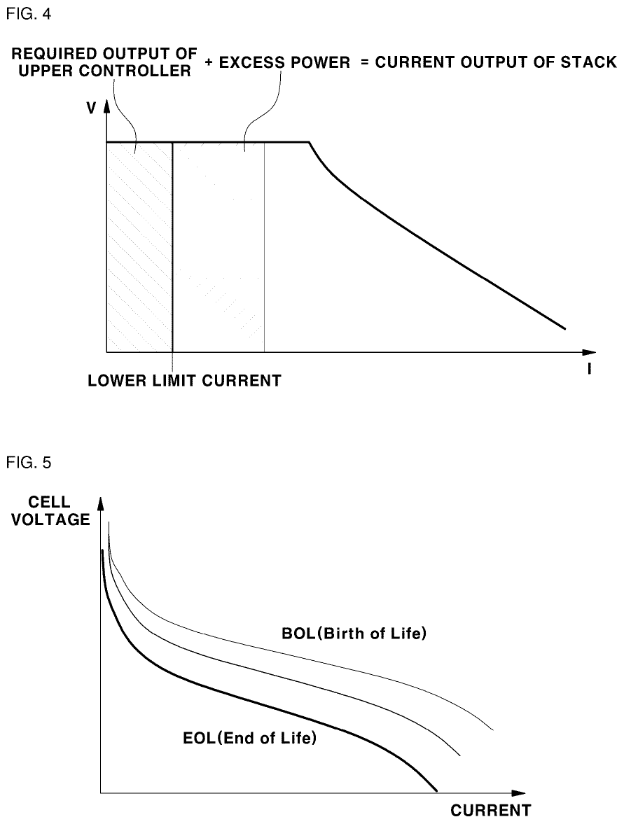

Accordingly, a low-flow control (voltage upper limit control) section (region) may be identified from the current-voltage performance curve of the stack estimated by the current-voltage curve estimation circuit 210, as shown in the graph of FIG. 4 (e.g., a region where the stack voltage approaches 0.8 V under declining current, or where precision airflow regulation is required to avoid overvoltage, etc.).

The lower limit current determination circuit 220 of the air supply controller 200 is configured to determine whether a stack current generated in the stack during low-flow control is less than or equal to a lower limit current of the stack determined in advance according to the SoH of the current stack (e.g., by referencing SoH-based lookup tables, preloaded test data, or adaptive thresholds calculated from real-time I-V behavior, etc.).

For example, a lower limit current value according to the SoH of the stack may be determined in advance through testing, as described in the following Table 1 (e.g., using durability degradation benchmarks, cell voltage imbalance trends, or worst-case airflow scenarios, etc.).

TABLE 1

| SOH[%] | 100 | 90 | 80 | 70 | 60 | 50 | 40 | 30 | 20 | 10 |
|---|---|---|---|---|---|---|---|---|---|---|
| LOWER LIMIT | 6 | 6 | 10.5 | 12 | 15 | 21 | 24 | 30 | 39 | 45 |
| CURRENT[A] | | | | | | | | | | |

The lower limit current according to the SoH of the stack is determined as a reference current value for determining whether a minimum cell voltage ratio (RV) of the stack decreases according to low-flow control.

Accordingly, the lower limit current determination circuit 220 determines whether the current of the stack is less than or equal to the lower limit current (stack current≤lower limit current) while monitoring the current of the current stack in a state of knowing the lower limit current according to the SoH of the stack (e.g., by sampling real-time stack current data and comparing it to threshold values indexed by SoH, etc.).

The air flow rate increase control circuit 230 of the air supply controller 200 is configured to perform increase control of the air flow rate supplied to the stack in an upper limit voltage control region for low-flow control estimated by the current-voltage curve estimation circuit 210 (e.g., a region in which the stack operates near 0.8 V and requires precise airflow to avoid RV degradation, cell imbalance, or overvoltage stress, etc.). The air flow rate increase control circuit 230 of the air supply controller 200 is further configured to perform increase control of the air flow rate supplied to the stack if the current of the stack is determined to be less than or equal to the lower limit current by the lower limit current determination circuit 220 (e.g., to prevent stack voltage imbalance, localized oxygen starvation, or long-term durability loss, etc.). For example, the air flow rate increase control circuit 230 may include a power consumption determination circuit 231 that calculates power consumable by a power consumption load (e.g., based on real-time resistance values, load profiles, or system operating conditions, etc.), a stack requirement power increase determination circuit 232 that determines stack requirement power increased by the amount of consumable power determined by the power consumption determination circuit 231 (e.g., by summing the commanded power from an upper controller with the available load capacity, etc.), and a driving control circuit 233 that controls the rotation speed of the air blower to supply an air flow rate to the stack based on the stack requirement power determined by the stack requirement power increase determination circuit 232 (e.g., using RPM control maps, PID-based flow tuning, or adaptive airflow feedback, etc.).

The power consumption determination circuit 231 of the air flow rate increase control circuit 230 is configured to determine power consumable by loads such as COD (Cathode Oxygen Depletion), a battery, and BOP (Balance of Plant), which are connected to a power net of a fuel cell system (e.g., through electrical load models, instantaneous resistance calculations, or SOC-based charging maps, etc.).

For example, the COD is a resistor used to control the remaining oxygen of the stack or to increase a temperature of the fuel cell system, and may be configured as a relay on/off type or an IGBT (Insulated Gate Bipolar Transistor) type. The battery is for charging with power generated in the stack (e.g., during surplus generation events or regenerative phases, etc.). The BOP refers to power-consuming electrical components included in the fuel cell system, such as a cooling water pump and an air blower (e.g., fans, valves, or coolant heaters, etc.).

Accordingly, the power consumption determination circuit 231 may be configured to determine consumable power as one selected from among COD consumable power, battery rechargeable power, and BOP consumable power, or to determine consumable power as the sum of COD consumable power, battery rechargeable power, and BOP consumable power (e.g., based on current load availability, system limits, or dynamic power distribution logic, etc.).

The stack requirement power increase determination circuit 232 of the air flow rate increase control circuit 230 is configured to determine stack requirement power to be the sum of commanded stack requirement power commanded by the upper controller and consumable power determined by the power consumption determination circuit 231 (e.g., to ensure sufficient airflow while maintaining net power output at the level requested by the upper controller, etc.).

In detail, to solve a problem in that the air flow rate supplied to the stack decreases according to the stack requirement power commanded to be decreased by the upper controller during low-flow control (e.g., leading to reduced oxygen availability, increased cell-to-cell voltage deviation, or premature voltage limit engagement, etc.), which causes an imbalance in the air supply in the stack and lowers the minimum cell voltage ratio (RV) (e.g., a predetermined cell voltage ratio) of the stack, the stack requirement power increase determination circuit 232 is configured to determine the stack requirement power to be the sum of the commanded stack requirement power commanded by the upper controller and the consumable power determined by the power consumption determination circuit 231 (e.g., enabling recovery of airflow margin to mitigate oxygen starvation and voltage instability across stack cells, etc.).

Accordingly, the stack requirement power increase determination circuit 232 determines to increase the stack requirement power by the sum of the commanded stack requirement power commanded by the upper controller during low-flow control and the consumable power determined by the power consumption determination circuit 231, so that the stack requirement power increases, and the air flow rate supplied to the stack increases, which may resolve the imbalance of air supply in the stack and the decrease in the minimum cell voltage ratio (RV) (e.g., predetermined cell voltage ratio) of the stack (e.g., due to insufficient oxygen delivery or uneven flow distribution across the stack, etc.).

The driving control circuit 233 of the air flow rate increase control circuit 230 is configured to control the rotation speed of the air blower 300 to supply the air flow rate to the stack based on the stack requirement power determined by the stack requirement power increase determination circuit 232 (e.g., by adjusting motor voltage, using blower maps, or applying closed-loop feedback from mass airflow sensors, etc.

For example, the driving control circuit 233 performs a control operation to increase the rotation speed of the air blower 300 to increase the air flow rate supplied to the stack according to the stack requirement power (i.e., the sum of the commanded stack requirement power from the upper controller and the consumable power determined by the power consumption determination unit) determined by the stack requirement power increase determination circuit 232 (e.g., to meet airflow needs without exceeding the net power requested by the upper controller, etc.).

Accordingly, the air flow rate supplied to the stack during low-flow control increases, thereby resolving the imbalance in the air supply in the stack and the decrease in the minimum cell voltage ratio (RV) of the stack (e.g., by improving oxygen uniformity across cell channels and stabilizing voltage distribution, etc.).

Meanwhile, the air flow rate increase control circuit 230 is configured to terminate increase control of the air flow rate if a required current of the upper controller is greater than the lower limit current of the stack determined according to the SoH of the stack (e.g., indicating a transition back to normal load conditions where airflow boosting is no longer needed, etc.).

For example, if a required current value determined by being requested by the upper controller while maintaining net power through the power consumption load 400 is greater than the lower limit current of the current SoH, the flow rate increase control is terminated (e.g., because the system has exited the voltage-limiting condition and additional airflow adjustment is no longer necessary, etc.).

In this instance, the above power consumption load 400 consumes excess power generated in the stack as the air flow rate supplied to the stack increases, and may include COD, a battery, and BOP, or may be one selected from among COD, a battery, and BOP (e.g., depending on available capacity, thermal management strategy, or electrical priority, etc.).

The power consumption control circuit 240 of the air supply controller 200 determines power consumed by the power consumption load 400, for example, the excess power generated in the stack, and performs a control operation so that the power consumption load 400 consumes the determined excess power (e.g., by activating load elements such as resistive heaters, initiating battery charging, or enabling auxiliary devices, etc.).

For example, if the stack current is greater than the required current of the upper controller, as shown in FIG. 4, the current output of the stack is determined to be the sum of the required output of the upper controller and the excess power generated by the stack (e.g., due to increased airflow for RV stabilization or operational buffer, etc.), and thus the power consumption control circuit 240 may determine the excess power generated in the stack to be a value obtained by subtracting the required output of the upper controller from the current output of the stack (e.g., using real-time power measurements or estimated load demand differentials, etc.). And the power consumption control circuit 240 may perform a control operation to operate the power consumption load 400 so that the determined excess power is consumed by the power consumption load 400 (e.g., to maintain stable net output and prevent overvoltage or battery overcharging, etc.).

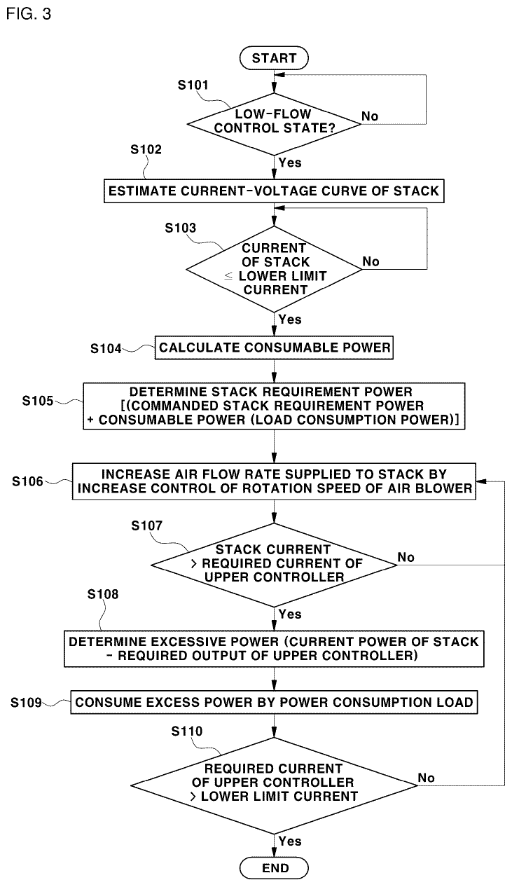

Here, a method of controlling air supply to the fuel cell according to the present disclosure based on the above-mentioned configuration is examined as follows (e.g., shown in the flowchart of FIG. 3, showing the sequence of SoH-based threshold comparison, airflow adjustment, and power load control, etc.).

FIG. 3 shows an example of the method of controlling air supply to the fuel cell according to the present disclosure.

First, it is determined whether a low-flow control state is obtained (S101).

In the low-power section of the stack, it is possible to perform low-flow control in which the air flow rate supplied to the stack by the air supply controller 200 is not boosted and is precisely controlled and supplied according to a command of the upper controller 100, and thus the air supply controller 200 may determine whether the low-flow control state is obtained (e.g., by detecting that the stack voltage is approaching a predefined upper limit while the requested power is below a threshold, etc.).

Next, the current-voltage curve of the current stack is estimated using the SoH of the stack (S102).

As described above, the current-voltage curve estimation circuit 210 of the air supply controller 200 estimates the current-voltage performance curve of the current stack to determine the low-flow control (voltage upper limit control) region using the SoH of the stack (e.g., by referencing performance data between the Bol and EoL operating states, etc.).

Next, it is determined whether the current of the stack is less than or equal to the lower limit current of the stack determined according to the SoH of the current stack during low-flow control (S103) (e.g., to identify a condition where airflow compensation is needed to prevent voltage instability, etc.).

As described above, the lower limit current determination circuit 220 of the air supply controller 200 determines whether the current of the stack generated in the stack during low-flow control is less than or equal to the lower limit current of the stack determined in advance according to the SoH of the current stack (current of stack≤lower limit current) (e.g., by comparing live current readings to threshold values stored in a lookup table indexed by SoH, etc.).

Next, if the current of the stack is determined to be less than or equal to the lower limit current in step S103, it is determined that an increase in the air flow rate supplied to the stack is necessary, and thus a control operation is performed to increase the air flow rate supplied to the stack (e.g., to prevent deterioration of the voltage balance and ensure continued operation within safe stack conditions, etc.).

In particular, the step of performing the control operation to increase the air flow rate supplied to the stack may include a power consumption determination step (S104) of calculating power consumable by the power consumption load 400 (e.g., based on load availability, operating constraints, or system efficiency targets, etc.), a stack requirement power determination step (S105) of determining stack requirement power that increases by the consumable power determined in the power consumption determination step (e.g., to ensure sufficient airflow while maintaining the net power output requested by the upper controller, etc.), and a step (S106) of controlling the rotation speed of the air blower to supply the air flow rate to the stack based on the stack requirement power determined in the stack requirement power determination step, for example, to increase the air flow rate supplied to the stack (e.g., while maintaining the net power delivered to the upper controller within the original target range, etc.).

In the power consumption determination step (S104), the power consumption determination circuit 231 of the air supply controller 200 may determine consumable power to be one selected from among COD consumable power, battery rechargeable power, and BOP consumable power, or may determine consumable power to be the sum of the COD consumable power, the battery rechargeable power, and the BOP consumable power (e.g., depending on current SOC level, thermal limits, or available electrical load margin, etc.).

In the stack requirement power determination step (S105), the stack requirement power increase determination circuit 232 of the air supply controller 200 may determine the stack requirement power (i.e., the total required power to be delivered by the stack) (commanded stack requirement power+consumable power (load consumption power) to be the sum of the commanded stack requirement power commanded by the upper controller and the consumable power (load consumption power) determined by the power consumption determination circuit 231 (e.g., to meet airflow demands while holding net power output steady, etc.).

In step (S106) of controlling the rotation speed of the air blower, when the rotation speed of the air blower is increased based on the stack requirement power (e.g., sum of commanded stack requirement power and consumable power (load consumption power)) determined in the stack requirement power determination step (S105), the flow rate of air supplied to the stack may be increased (e.g., by issuing a corresponding blower command signal mapped to the updated stack requirement power, etc.).

In this instance, as the flow rate of air supplied to the stack increases, excess power may be generated due to the operation of the stack by the amount of the increase in the air flow rate, and the stack current may become larger than the current required for low-flow control of the upper controller due to the excess power generation (e.g., resulting in net output above the command target, which requires dissipation or redistribution, etc.).

Accordingly, the power consumption control circuit 240 of the air supply controller 200 monitors whether the stack current is greater than the required current of the upper controller (S107) (e.g., using a comparator circuit or software threshold monitor, etc.).

If the stack current is greater than the required current of the upper controller as a result of monitoring, the power consumption control circuit 240 determines power consumed by the power consumption load 400, for example, excess power generated in the stack to be a value obtained by subtracting the required output of the upper controller from the current output of the stack (S108) (e.g., ensuring surplus energy is properly routed to maintain power balance and protect system components, etc.).

For example, if the stack current is greater than the required current of the upper controller, the current output of the stack is determined to be the sum of the required output of the upper controller and the excess power generated in the stack due to the increased air flow rate supplied to the stack, as shown in FIG. 4 (e.g., reflecting the additional power produced beyond what is needed for traction or auxiliary loads, etc.). Thus, the power consumption control circuit 240 may determine the power consumed by the power consumption load 400, for example, the excess power generated in the stack to be the value obtained by subtracting the required output of the upper controller from the current output of the stack (e.g., ensuring that the surplus power is absorbed by appropriate load paths to maintain system balance and avoid overcharging or thermal overrun, etc.).

Next, as the air flow rate supplied to the stack increases, a step is performed in which the excess power generated in the stack is consumed by the power consumption load (S109) (e.g., to maintain net power balance and prevent overvoltage conditions, etc.).

To this end, the power consumption control circuit 240 performs a control operation to consume the power consumed by the power consumption load 400, for example, the excess power generated in the stack, by the power consumption load 400 (e.g., by activating or modulating one or more load components depending on availability and demand, etc.).

For example, the power consumption control circuit 240 performs a control operation to operate the power consumption load 400 so that the excess power determined in the step S108 is consumed by the power consumption load 400 (e.g., by issuing control signals to activate or modulate specific load components based on available capacity and system priorities, etc.).

Accordingly, the excess power may be consumed by the power consumption load 400 including the COD, the battery, and the BOP, or the excess power may be consumed by one power consumption load 400 selected from among the COD, the battery, and the BOP (e.g., depending on system operating mode, charge level, or thermal constraints, etc.).

In other words, as the air flow rate supplied to the stack is increased to prevent a phenomenon in which the minimum cell voltage ratio of the stack decreases during low-flow control and voltage upper limit control, the excess power (surplus power) generated in the stack may be consumed by the power consumption load 400 (e.g., to enable controlled airflow compensation while holding system output steady, etc.).

In detail, in the power consumption determination step (S104), the consumable power is determined to be one selected from among COD consumable power, battery rechargeable power, and BOP consumable power. Alternatively, the consumable power is determined to be the sum of COD consumable power, battery rechargeable power, and BOP consumable power (e.g., based on real-time load availability, power demand balancing, or thermal constraints, etc.). Thus, excess power may be easily consumed by the power consumption load 400 including COD, a battery, and BOP, or excess power may be easily consumed by one power consumption load 400 selected from among COD, a battery, and BOP (e.g., based on load response time, energy absorption capacity, or priority level assigned to each load type, etc.).

While increase control of the air flow rate is performed, whether the required current of the upper controller is greater than the lower limit current of the stack determined according to the SoH of the stack is monitored (S110) (e.g., to determine whether continued airflow boosting is necessary for voltage stability, etc.). If the required current of the upper controller is greater than the lower limit current of the stack determined according to the SoH of the stack, increase control of the air flow rate is terminated (e.g., indicating a transition out of the low-flow control condition, where additional airflow is no longer needed to stabilize RV, etc.).

For example, if the required current value determined by being requested by the upper controller is greater than a lower limit current determined based on the current SoH, the air flow rate increase control circuit 230 determines that low-flow control is terminated and terminates increase control of the air flow rate.

In this way, by increasing the air flow rate supplied to the stack during low-flow control and voltage upper limit control and consuming excess power generated in the stack, it is possible to prevent a phenomenon of a decrease in the minimum cell voltage ratio (e.g., a predetermined cell voltage ratio) of the stack, and accordingly, cell performance of the stack and durability of the stack may be improved while maintaining operating efficiency of the fuel cell system (e.g., by preventing localized overvoltage and ensuring uniform reactant distribution across all cells, etc.).

FIG. 6 shows an example computing system (e.g., a computing device of a vehicle or any other apparatus). One or more controllers, processors, etc. described herein, such as one or more components of the vehicle 100 (e.g., DCCU), one or more components of the management server 200, one or more components of the user terminal 300, and any other components and devices disclosed herein, may be implemented by or in the computing system as shown in FIG. 3.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The present disclosure is intended to solve the above-mentioned problems of the related art, and an object of the present disclosure is to provide a system and method for controlling air supply to a fuel cell, which estimates a current current-voltage curve of a current stack by utilizing an SoH (State of Health) of the stack to determine a low-flow control point, determines whether a current of the stack is less than or equal to a lower limit current of the stack determined by the SoH of the stack during low-flow control, and increases an air flow rate supplied to the stack and enables consumption of excess power generated in the stack if the current of the stack is less than or equal to the lower limit current, thereby preventing a phenomenon in which a minimum cell voltage ratio is lowered due to low-flow control and voltage upper limit control.

In one example, the present disclosure provides a system for controlling air supply to a fuel cell, the system including a current-voltage curve estimation circuit configured to estimate a current-voltage performance curve of a current stack using a State of Health (SoH) of a stack, a lower limit current determination circuit configured to determine whether a current of the stack is less than or equal to a lower limit current of the stack determined according to the SoH of the stack during low-flow control, an air flow rate increase control circuit configured to perform increase control of an air flow rate supplied to the stack upon determining that the current of the stack is less than or equal to the lower limit current, and a power consumption load configured to consume excess power generated in the stack as the air flow rate supplied to the stack increases.

In a preferred example, the air flow rate increase control circuit may include a power consumption determination circuit configured to calculate power consumed by the power consumption load, a stack requirement power increase determination circuit configured to determine stack requirement power increased by consumable power determined by the power consumption determination circuit, and a driving control circuit configured to control a rotation speed of an air blower to supply the air flow rate to the stack based on the stack requirement power determined by the stack requirement power increase determination circuit.

In another preferred example, the air flow rate increase control circuit may be configured to perform increase control of the air flow rate supplied to the stack in a voltage upper limit control region for low-flow control.

In still another preferred example, the air flow rate increase control circuit may be configured to terminate increase control of the air flow rate if a required current of the upper controller is greater than the lower limit current of the stack determined according to the SoH of the stack.

In yet another preferred example, the power consumption determination circuit may be configured to determine consumable power to be one selected from among Cathode Oxygen Depletion (COD) consumable power, battery rechargeable power, and Balance of Plant (BOP) consumable power, or to determine consumable power to be a sum of the COD consumable power, the battery rechargeable power, and the BOP consumable power.

In still yet another preferred example, the stack requirement power increase determination circuit may be configured to determine the stack requirement power to be a sum of commanded stack requirement power commanded by the upper controller and consumable power determined by the power consumption determination circuit.

In a further preferred example, the system may further include a power consumption control circuit configured to determine excess power generated in the stack consumed by the power consumption load.

In another further preferred example, the power consumption control circuit may be configured to determine the excess power to be a value obtained by subtracting required output of the upper controller from stack output if the stack current is greater than a required current of the upper controller.

In still another further preferred example, the power consumption load may be configured as COD, a battery, and BOP, or is one selected from among the COD, the battery, and the BOP.

In another example, the present disclosure provides a method of controlling air supply to a fuel cell, the method including estimating a current-voltage performance curve of a current stack using an SoH of a stack, determining whether a current of the stack is less than or equal to a lower limit current of the stack determined according to the SoH of the stack during low-flow control, performing increase control of an air flow rate supplied to the stack upon determining that the current of the stack is less than or equal to the lower limit current, and consuming, by a power consumption load, excess power generated in the stack as the air flow rate supplied to the stack increases.

In a preferred example, the performing increase control of an air flow rate may include calculating power consumed by the power consumption load, determining stack requirement power increased by consumable power determined in the calculating power consumed by the power consumption load, and controlling a rotation speed of an air blower to supply the air flow rate to the stack based on the stack requirement power determined in the determining stack requirement power.

In another preferred example, the method may further include terminating increase control of the air flow rate if a required current of an upper controller is greater than the lower limit current of the stack determined according to the SoH of the stack while the increase control of the air flow rate is performed.

In still another preferred example, the calculating power consumed by the power consumption load may include determining consumable power to be one selected from among COD consumable power, battery rechargeable power, and BOP consumable power, or determining consumable power to be a sum of the COD consumable power, the battery rechargeable power, and the BOP consumable power.

In yet another preferred example, the determining stack requirement power may include determining the stack requirement power to be a sum of commanded stack requirement power commanded by an upper controller and consumable power determined by a power consumption determination circuit.

In still yet another preferred example, the method may further include determining excess power generated in the stack consumed by the power consumption load.

In a further preferred example, the determining excess power may include determining the excess power to be a value obtained by subtracting required output of an upper controller from stack output if the stack current is greater than a required current of the upper controller.

In another further preferred example, the consuming excess power generated in the stack may include consuming the excess power by the power consumption load including COD, a battery, and BOP, or consuming the excess power by one selected from among the COD, the battery, and the BOP.

Through the above-mentioned means for solving the problem, the present disclosure provides the following effects.

First, by increasing the air flow rate supplied to the stack during low-flow control and voltage upper limit control and allowing consumption of excess power generated in the stack, the phenomenon in which the minimum cell voltage ratio of the stack decreases may be prevented, and accordingly, cell performance of the stack and durability of the stack may be improved while maintaining operating efficiency of the fuel cell system (e.g., avoiding premature degradation or sharp voltage drops in the weakest cells, etc.).

Second, when performing low-flow control, it is possible to prevent a phenomenon of air supply imbalance in the stack (e.g., caused by insufficient airflow at the outlet cells or asymmetric flow channel resistance, etc.).

Third, since the phenomenon in which the minimum cell voltage ratio of the stack decreases may be prevented during low-flow control and voltage upper limit control, voltage upper limit control may be easily maintained in the low-flow control section (e.g., reducing the need for reactive airflow corrections and enhancing stability of control algorithms, etc.).

Even though the present disclosure has been described in detail as an example, the scope of the present disclosure is not limited to the above-described example, and various modifications and improvements made by those skilled in the art using the basic concept of the present disclosure defined in the following patent claims are included in the scope of the present disclosure.

What is claimed is:

1. An apparatus of a fuel cell system, the apparatus comprising:
a current-voltage curve estimation circuit configured to estimate, based on a state of health (SoH) of a fuel cell stack of the fuel cell system, a current-voltage performance curve of the fuel cell stack;
a lower limit current determination circuit configured to determine whether a current of the fuel cell stack is less than or equal to a lower limit current of the fuel cell stack, wherein the lower limit current is determined based on the SoH of the fuel cell stack under a condition in which a flow rate of air supplied to the fuel cell stack is reduced to maintain a voltage of the fuel cell stack within a voltage upper limit control region;
an air flow rate increase control circuit configured to increase, based on the current of the fuel cell stack being less than or equal to the lower limit current, the flow rate of air supplied to the fuel cell stack; and
a power load configured to receive and use excess power generated in the fuel cell stack as the flow rate of air supplied to the stack increases.

2. The apparatus of claim 1, wherein the air flow rate increase control circuit comprises:
a power consumption determination circuit configured to measure power used by the power load;
a stack requirement power increase determination circuit configured to determine, based on the measured power, stack requirement power; and
a driving control circuit configured to control, based on the determined stack requirement power, a rotation speed of an air blower to adjust the flow rate of air supplied to the fuel cell stack.

3. The apparatus of claim 2, wherein the air flow rate increase control circuit is configured to increase the flow rate of air supplied to the fuel cell stack in the voltage upper limit control region.

4. The apparatus of claim 1, wherein the air flow rate increase control circuit is configured to stop, based on a required current exceeding the lower limit current of the fuel cell stack, increasing the flow rate of air.

5. The apparatus of claim 2, wherein the power consumption determination circuit is configured to:
determine usable power to be at least one of Cathode Oxygen Depletion (COD) consumable power, battery rechargeable power, or Balance of Plant (BOP) consumable power, or
determine consumable power based on a sum of the COD consumable power, the battery rechargeable power, and the BOP consumable power.

6. The apparatus of claim 2, wherein the stack requirement power increase determination circuit is configured to determine the stack requirement power based on a sum of commanded stack requirement power and usable power, wherein the usable power is determined by the power consumption determination circuit.

7. The apparatus of claim 1, further comprising a power consumption control circuit configured to:
determine excess power generated in the fuel cell stack, and
control the power load to use the determined excess power.

8. The apparatus of claim 7, wherein the power consumption control circuit is configured to determine the excess power based on:
a difference between a required output power and an output power of the fuel cell stack, and
a current of the fuel cell stack exceeding a required current associated with the required output power.

9. The apparatus of claim 1, wherein the power load comprises at least one of a cathode oxygen depletion (COD) resistor, a battery, or a balance of plant (BOP) component.

10. A method performed by an apparatus of a fuel cell system, the method comprising:
estimating, based on a state of health (SoH) of a fuel cell stack of the fuel cell system, a current-voltage performance curve of the fuel cell stack;
determining whether a current of the fuel cell stack is less than or equal to a lower limit current of the fuel cell stack, wherein the lower limit is determined based on the SoH of the fuel cell stack under a condition in which a flow rate of air supplied to the fuel cell stack is reduced to maintain a voltage of the fuel cell stack within a voltage upper limit control region;
increasing, based on the current of the fuel cell stack being less than or equal to the lower limit current, the flow rate of air supplied to the fuel cell stack; and
transferring, to a power load of the apparatus, excess power generated in the fuel cell stack as the flow rate of air supplied to the stack increases.

11. The method of claim 10, wherein the increasing of the flow rate of air comprises:
measuring power used by the power load;
determining, based on the measured power, stack requirement power; and
controlling, based on the determined stack requirement power, a rotation speed of an air blower to adjust the flow rate of air supplied to the fuel cell stack.

12. The method of claim 10, further comprising:
based on a required current exceeding the lower limit current of the fuel cell stack, stop increasing the flow rate of air.

13. The method of claim 11, wherein the measuring of power used by the power load comprises:
determining usable power to be at least one of Cathode Oxygen Depletion (COD) consumable power, battery rechargeable power, or Balance of Plant (BOP) consumable power; or
determining consumable power based on a sum of the COD consumable power, the battery rechargeable power, and the BOP consumable power.

14. The method of claim 11, wherein the determining of the stack requirement power comprises determining the stack requirement power based on a sum of commanded stack requirement power and usable power.

15. The method of claim 10, further comprising:
determining excess power generated in the fuel cell stack; and
controlling the power load to use the determined excess power.

16. The method of claim 15, wherein the determining of the excess power comprises determining the excess power based on:
a difference between a required output power and an output power of the fuel cell stack, and
a current of the fuel cell stack exceeding a required current associated with the required output power.

17. The method of claim 10, wherein the power load comprises at least one of a cathode oxygen depletion (COD) resistor, a battery, and a balance of plant (BOP) component.

18. An apparatus of a fuel cell system, the apparatus comprising:
a processor; and
a memory storing at least one instruction that, when executed by the processor communicating with the memory, is configured to cause the apparatus to:
identify, based on a performance characteristic of a fuel cell stack of the fuel cell system, a threshold current value for maintaining a target operating condition of the fuel cell stack;
compare, based on a flow rate of air supplied to the fuel cell stack being reduced to control a voltage of the fuel cell stack, an operating current of the fuel cell stack to the threshold current value;
generate, based on the operating current being less than or equal to the threshold current value, a signal indicating to increase the flow rate of air supplied to the fuel cell stack;
identify an amount of electrical power resulting from the increased flow rate of air; and
control a load of the fuel cell system to use at least a portion of the electrical power.

19. The apparatus of claim 18, wherein the threshold current value is associated with a state of health (SoH) value of the fuel cell stack.

20. The apparatus of claim 18, wherein the at least one instruction, when executed by the processor communicating with the memory, is configured to cause the apparatus to:
determine that the fuel cell stack is operating in a low-power mode based on the operating current of the fuel cell stack less than or equal to the threshold current value, and
initiate, based on the determination that the fuel cell stack is operating in the low-power mode, an increase in the flow rate of air supplied to the fuel cell stack.
